(19) United States
(12) Patent Application Publication
(10) Pub. No.: US 2014/0129325 A1
(43) Pub. Date: May 8, 2014

(54) Method and System for Advertisement Replacement

(71) Applicant: T.L.V. MEDIA ON LINE LTD, Tel Aviv (IL)

(72) Inventors: Ofer Zinger, Tel Aviv (IL); Ohad Gliksman, Ramat Gan (IL)

(73) Assignee: T.L.V. MEDIA ON LINE LTD, Tel Aviv (IL)

(21) Appl. No.: 13/668,413

(22) Filed: Nov. 5, 2012

(51) Int. Cl. G06Q 30/02

(52) U.S. Cl. 705/14.46; 705/14.73; 705/14.68

(57) ABSTRACT

A method, system and product useful for online advertisement. The method comprising: displaying a first advertisement in a web page, wherein the first advertisement is associated with a compensation model that is contingent on a user action by a user with the first advertisement; and replacing the first advertisement by a second advertisement that is associated with a serving-based compensation model. In some embodiments, the first advertisement is replaced in response to a determination that a probability that the user action will be performed by the user is below a predetermined threshold. In some embodiments, the first advertisement is replaced in response to a determination that a predetermined threshold time has elapsed after said displaying the first advertisement. In some embodiments, the predetermined threshold time is computed for an ad impression relating to the first advertisement, to the user and to the web page.

### TECHNICAL FIELD

The present disclosure relates to online advertisements in general, and to online advertisement placement in online web pages, in particular.

### BACKGROUND

According to one definition, advertising is a paid, one-way communication through a medium in which an advertiser may be identified, and the message (i.e., the advertisement or ad) provided by the advertiser is controlled. Advertising may be performed for a variety of purposes, including sales promotion, publicity, public relations, product placement, sponsorship, and underwriting. A variety of mediums are used to convey an advertisement, including television, radio, movies, magazines, newspapers, the Internet, and billboards.

Online Advertising relates to the promoting of products and services using computerized networks such as the Internet and World Wide Web (WWW). Typical online advertisement types include banner ads, floating ads, pop-up ads, and video ads which are provided to a user via the user's computerized device. The user may be browsing websites and in each such website, one or more ads may be displayed. Additionally or alternatively, the ads may be displayed within a component of a website, such as a Flash-based video-player, or the like. Any location in which an ad can be displayed may be referred to as a placeholder.

There are several advertisement compensation models known in the art. A first model is a user action-based compensation model, which includes Cost Per Click (CPC), Click Per Action (CPA), Cost Per Lead (CPL), or the like. In a user action-based compensation model, the compensation by the advertiser to the owner of the placeholder is contingent upon an action by the person to which the advertisement is targeted (also referred to as a user), such as a click, leaving a lead, performing a predetermined action or acquisition within a site of the advertiser, or the like.

A second model is a serving-based compensation model in which the compensation is not dependent on an audience action, but rather on serving the ad and providing it to the audience. The serving-based compensation model includes, for example, Cost Per View (CPV), Cost Per Mille Impression (CPM), or the like.

An “impression” or “ad impression” as used herein and is understood by person of ordinary skill in the art refers to a placement of an advertisement of a campaign in a placeholder for a user. In some exemplary embodiments, each time an ad is served and displayed, it is considered an impression.

### BRIEF SUMMARY

One exemplary embodiment of the disclosed subject matter is a computer-implemented method performed by a computerized device, comprising: displaying a first advertisement in a web page, wherein the first advertisement is associated with a compensation model that is contingent on a user action by a user with the first advertisement; and replacing the first advertisement by a second advertisement that is associated with a serving-based compensation model.

Optionally, the replacing is performed in response to a determination that a probability that the user action will be performed by the user is below a predetermined threshold.

Optionally, the replacing is performed in response to a determination that a predetermined threshold time has elapsed after the first advertisement is displayed.

Optionally, the predetermined threshold time is computed for an ad impression relating to the first advertisement, to the user and to the web page.

Optionally, the replacing is performed in response to estimating, based on usage of a pointing device by the user, that a probability that the user will perform the user action is below a predetermined threshold.

Optionally, the replacing is timed based on a computation of an Estimated Revenue Per Impressions Time Unit (ERPITU).

Optionally, the replacing is timed based on a time unit during which the ERPITU is below a predetermined revenue, wherein the predetermined revenue is associated with expected alternative revenue of the second advertisement.

Optionally, the serving-based compensation model is a Cost Per Mille-impression (CPM) compensation model.

Optionally, the serving-based compensation model is a Cost Per Impression Time Unit (CPITU) compensation model.

Optionally, the compensation model that is contingent on the interaction with the first advertisement is either a Cost Per Click (CPC) compensation model, a Cost Per Action (CPA) compensation model, a Cost Per Lead (CPL) compensation model, or a combination thereof

Optionally, the replacing comprises: sending a request to an advertisement serving server to select the second advertisement from a set of advertisement that are associated with the serving-based compensation model; and receiving from the advertisement server the second advertisement.

Optionally, the method further comprises rotating the second advertisement with one or more additional advertisements that are associated with the serving-based compensation model.

Optionally, the replacing is performed without reloading the web page.

Optionally, the replacing comprises performing a passback, whereby an economic entity responsible for compensating is changed.

Optionally, the replacing is performed while the web page is displayed.

Another exemplary embodiment of the disclosed subject matter is a computerized apparatus having a processor, the processor being adapted to perform the steps of: displaying a first advertisement in a web page, wherein the first advertisement is associated with a compensation model that is contingent on a user action by a user with the first advertisement; and replacing the first advertisement by a second advertisement that is associated with a serving-based compensation model.

Optionally, the replacing is performed in response to a determination that a probability that the user action will be performed by the user is below a predetermined threshold.

Optionally, the replacing is performed in response to a determination that a predetermined threshold time has elapsed after the displaying the first advertisement.

Optionally, the predetermined threshold time is computed for an ad impression relating to the first advertisement, to the user and to the web page.

Optionally, the replacing is timed based on a computation of an Estimated Revenue Per Impressions Time Unit (ERPITU).

Optionally, the processor is further adapted to: send a request to an advertisement serving server to select the second advertisement from a set of advertisement that are associated with the serving-based compensation model; and receive from the advertisement server the second advertisement.

Yet another exemplary embodiment of the disclosed subject matter is a computer program product comprising a non-transitory computer readable medium retaining program instructions, which instructions when read by a processor, cause the processor to perform the steps of: displaying a first advertisement in a web page, wherein the first advertisement is associated with a compensation model that is contingent on a user action by a user with the first advertisement; and replacing the first advertisement by a second advertisement that is associated with a serving-based compensation model.

Optionally, the instructions when ready by the processor further cause the processor to perform the steps of: obtaining from a server a time threshold in which the replacing is to be performed; wherein the replacing is performed in response to a determination that an elapsed time since the displaying exceeds the time threshold.

Optionally, the time threshold is computed by the server based on parameters associated with the user.

Yet another exemplary embodiment of the disclosed subject matter is a computer-implemented method performed by a computerized device, comprising: tracking time elapsed after an advertisement is displayed in a web page; and computing a compensation to be paid for the advertisement based on the time elapsed.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a computerized environment in which the disclosed subject matter is used, in accordance with some exemplary embodiments of the subject matter;

FIGS. 2A-2D show flowchart diagrams of methods, in accordance with some exemplary embodiments of the disclosed subject matter;

FIG. 3 shows a block diagram of an apparatus, in accordance with some exemplary embodiments of the disclosed subject matter; and

FIGS. 4A-4B show illustration of Effective Revenue Per Impression Time Unit, in accordance with some embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One problem dealt with by the disclosed subject matter is to increase the revenue generated from a placeholder. Another problem dealt with by the disclosed subject matter is to avoid losing compensation in case an advertisement which is contingent on user action is served and the user action is not performed. Yet another technical problem is to estimate whether or not the user action is about to be performed by the user. Yet another technical problem is to determine a point in time after which the excepted revenue from the action-based ad is estimated to be below a predetermined threshold.

One technical solution is to switch a compensation model after serving an advertisement. The disclosed subject matter may serve a first advertisement which is associated with a user action-based compensation model (also referred to as user action-based ad), and then initiate advertisement replacement into a second advertisement which is associated with a serving-based compensation model (also referred to as serving-based compensation model). In case the user-action is not performed, the first ad will not generate revenue. Replacing the advertisement to an advertisement of a different compensation model may provide for some compensation or alternative revenue generation.

The compensation from the serving-based advertisement may be lower than the compensation from the user action-based advertisement, and therefore the first advertisement may still be served based on the contingent compensation model. On average, the compensation to the owner of the placeholder may be higher than the compensation if the placeholder would have been used to display either type of advertisements alone. However, replacing the user action-based ad in a too early stage may reduce the revenue generated by the placeholder.

Furthermore, if the user action-based advertisement is replaced only in cases in which the user action will not be performed, there is no loss of any potential revenue. In such a case, the disclosed subject matter provides the same revenue or a higher revenue, relatively to simply serving the user action-based advertisement.

In some cases, there may be fewer available advertisements in a serving-based compensation model than in a user action-based compensation model. Therefore, attempting to first generate revenue based on the user action-based ad may enable the owner to generate higher revenue.

In some exemplary embodiments, the opportunity to place an ad in the placeholder for the user, also referred to as a placement opportunity, may be passbacked and given to another economic entity. In one scenario, a first economic entity may be given an opportunity to place a user action-based ad, such as a CPC ad. The placement opportunity may be given, for example, based on a matching algorithm by an Ad Server, based on a Real-Time Bidding (RTB) Server decision, or the like. Once it is estimated that the CPC ad will not generate any revenue or the expected revenue is determined to be too low, such as because it is estimated that the user is not likely to perform the action, the first economic entity may be given an opportunity to replace the ad by a second ad. The second ad may be a serving-based ad, such as CPM ad. However, in case the first economic entity cannot fulfill the placement opportunity or determines to intentionally not fulfill the placement opportunity, the placement opportunity may be passbacked to the owner of the placeholder or an agent representing the owner in selling the placement opportunity. The passbacked placement opportunity may be fulfilled by the owner (or its agent), such as by displaying a Public Service Announcement (PSA), a service-based ad, or the like. In some exemplary embodiments, the owner (or its agent) may resell the placement opportunity, such in an auction by an RTB Server, and thereby allow other economic entities to fulfill the placement opportunity.

Another technical solution is to automatically estimate whether the user is about to perform the action that the user action-based advertisement is contingent upon. In some exemplary embodiments, the estimation may be based on statistical analysis and may be performed such as by determining whether the probability that the user will perform the action is below a predetermined threshold, such as twenty percent, ten percent, five percent, or the like. The statistical analysis may be based on historic data relating to fulfillment of placement opportunities that are considered similar to the placement opportunity at hand. The characteristics which may be used to determine similarity between fulfilled placement opportunity may include parameters relating to the user to which the ad is shown (e.g., age, gender, location, socio-economic information, usage history of the web browser, clicking history, average time before click, impression history during a timeframe, such as during the last 24 hours, or the like), parameters relating to the campaign of the ad (e.g., average time until click, average viewing time of the ad, length of a video shown in the ad, type of product being advertised, or the like), parameters relating to the placement (e.g., containing web site, number of banners in the web site, location of the placeholder in the web page, size of the placeholder, clicking history within the web page, web site, placeholder, or the like, visitor statistics of the web site, or the like).

In some exemplary embodiments, the estimation whether the user is likely to perform the action may take into consideration the time elapsed since the ad was displayed (also referred to as display time), user's usage of a pointing device, such as a touch screen, a mouse, or the like, and other parameters.

In some exemplary embodiments, the estimation may be based on user's attention to portions of the web site, which may be tracked based on scrolling information, tracked eye movements, or the like.

In some exemplary embodiments, the estimation may be based on an Estimated Revenue Per Impressions Time Unit (ERPITU) of the ad impression. The ad impression may be the placement of the specific ad of a campaign to the specific user in a specific placement.

The ERPITU may be computed based on historic data, such as historic data relating to the user, to similar users, to the campaign to similar campaigns, to the placeholder, to similar placeholders, or the like.

The ERPITU may be a function of a time since the ad impression has been displayed. The time since the ad impression has been displayed may be referred to as “time offset” or “time shift” and it may be measured by any time unit. In some exemplary embodiments, the ERPITU may relate solely to time units in which the ad impression was visible to the user.

The ERPITU may be computed based on historic data, such as all the data, data that is characterized to relate to similar ad impressions based on the placement characteristics and/or campaign characteristics and/or user characteristics and/or other characteristics. In some exemplary embodiments, the ERPITU may be computed based on an average time to perform the user-action which the ad is contingent upon (e.g., click in a CPC ad). In some exemplary embodiments, the ERPITU may be computed based on an average time in which the ad impression was displayed and the action was not performed.

The ERPITU as a function of the time unit offset may be computed to determine expected revenue of each time unit offset. For example, the revenue from the first time unit may be 8 cents, the revenue from the second time unit may be 10 cents, the revenue from the third time unit may be 12 cents, the revenue from the fourth time unit may be 5 cents, the revenue from the fifth time unit may be 3 cents, and so forth.

Based on the ERPITU of the current time unit of the placement since it was displayed, it may be determined whether the user is likely to perform the action (e.g., click the CPC ad) or not. In some exemplary embodiments, the determination may depend on statistical analysis of the relevant historic data. For example, it may be assessed whether the probability that the user will performed the action is lower than a predetermined threshold, such as less than 5%, less than 10%, or the like. In some exemplary embodiments, the predetermined threshold may be based on the revenue from the action, such as in case that the action generates 2$ revenue, the threshold may be lower than if the action generates 10 cents revenue.

It will be noted that in some embodiments, a different ad impression (e.g., different user, different campaign and/or different placement) may be associated with a different ERPITU and the time until the action-based ad will be replaced may differ from one ad impression to another.

The ERPITU may refer to any time unit such as but not limited to a second, a millisecond, two seconds, 1.5 seconds, or the like.

In some exemplary embodiments, before switching the ad, the interaction of the user with the web page may be monitored to determine whether the user is about to interact with the ad, such as based on the usage of a pointing device by the user. Ad replacement may be avoided in such a case to prevent loss of revenue and frustrating the user that decided and began to execute, but have not yet completed, the interaction.

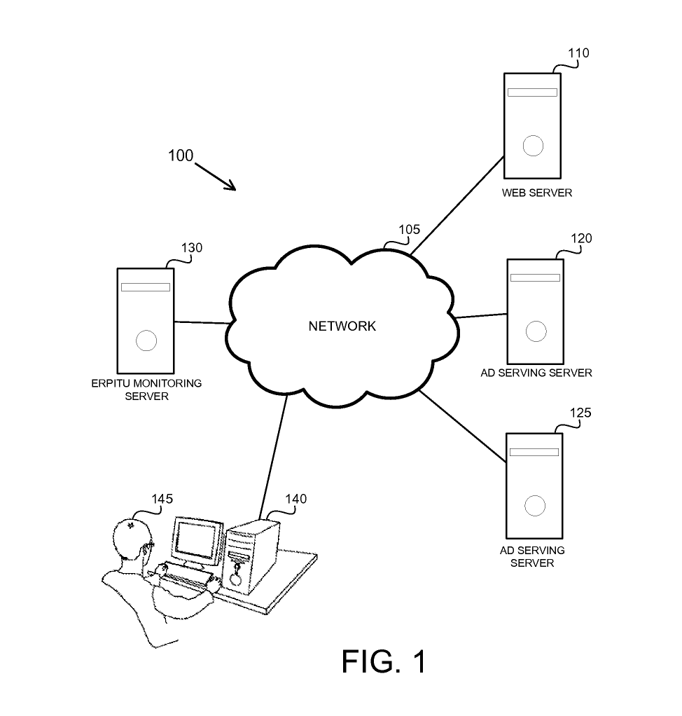

Referring now to FIG. 1 showing a computerized environment 100 in which the disclosed subject matter is used, in accordance with some exemplary embodiments of the subject matter.

A Network 105 of computerized devices, such as a LAN, a WAN, an intranet, the Internet, or the like may be used to connect between different devices. Network 105 may be a wired network, a wireless network, a combination thereof, or the like.

A User 145 may use a Device 140, such as a laptop computer, a mobile device, a smart phone, a desktop computer, or the like. User 145 may browse the WWW or other online content available on Network 105.

In one scenario, User 145 may browse to a web page of a web site, which is hosted on Web Server 110. Web Server 110 may retrieve the web page, such as an HTML file (static file, or a file that is dynamically generated), a Flash file, or the like and transmit the web site to Device 140. The web page may include at least one placeholder.

Ad Serving Server 120 may fulfill the placement opportunity in the placeholder by placing a first ad. In some exemplary embodiments, the website may include an HTML tag that is used to instruct Device 140 to provide Ad Serving Server 120 with the placement opportunity. Additionally or alternatively, the first ad may be added to the web site before serving the web site to Device 140.

In some exemplary embodiments, Ad Serving Server 120 may be a computerized server which matches the placement opportunity with the first ad, based on predetermined purchased inventory, such as purchasing a of bulk placements, based on RTB Auction, or the like.

The first ad may be a user action-based ad which generates revenue to the owner of the placeholder only in case a predetermined action is performed, such as the first ad is clicked by User 145, User 145 interacts with the first ad, User 145 purchases an item from a second web site which is linked to by the first ad, User 145 leaves lead information to be contacted, or the like.

The web site may include a client-side script, which may be implemented in JavaScript, PHP, Java, or the like, for replacing the first ad with a second ad, in accordance with the disclosed subject matter. In response to a determination that the first ad is to be replaced, a query may be sent to the Ad Serving Server 120 requesting a new ad that may be associated with a serving based model, such as based on displaying impressions (e.g., CPM), displaying impressions to unique visitors, or the like.

It will be understood that the term “Mille-impression” is used in the industry instead of relating to a single impression, as a cost of a single impression may be nominal and therefore, for the convenience of all relevant parties, the cost may be measured by a thousand impressions. However, the disclosed subject matter uses this term without limiting the cost module to only that of 1000 impressions, and it should be understood as including a pricing scheme that is based on any predetermined number of impressions that are provided (e.g., a cost per 1000 impressions, a cost per 95 impressions, a cost per impression, or the like). Likewise, any other unit may be replaced by a multiplicity of the unit. As an example, the unit of impression seconds may be replaced by mille impression seconds.

In some exemplary embodiments, the placement opportunity may be passbacked by Ad Serving Server 120, such as when no matching ad is found. The placement opportunity may be provided to another Ad Serving Server, such as Ad Serving Server 125 which may be given the placement opportunity and which may provide the second ad. During a passback operation, the economic entity which pays for the serving of the ad may change, such that instead of the owner of Ad Serving Server 120 (who may collect the cost from his client), the owner of Ad Serving Server 125 (who may collect the cost from her client) may pay for the ad placement.

In some exemplary embodiments, the second ad may be determined using an RTB auction for a serving-based ad to fulfill the placement opportunity.

An ERPITU Monitoring Server 130 may be configured to monitor information useful for calculating ERPITU values of each ad impression. The ERPITU may be used as a metric that is useful in online advertising. Additionally or alternatively, ERPITU may be used to estimate whether a user is likely to interact with an action-based ad. The ERPITU may be a function of the time offset since the ad was displayed. In some cases, as the time progresses, it is less likely that the user will interact with the ad and therefore the ERPITU may decrease as the time passes. The ERPITU function may be computed based on data of tracked interactions by users with respect to campaigns that are placed in placeholders. In some exemplary embodiments, the function may be computed based on users/campaigns/placeholders that are considered similar to that of the ad impression for which the ERPITU is computed.

In some exemplary embodiments, ERPITU Monitoring Server 130 may obtain information relating to users, campaigns, placeholders, and time until the action on which the revenue is contingent is performed, also referred to as “click time”. Additionally or alternatively, ERPITU Monitoring Server 130 may obtain information relating to users, campaigns, placeholders and time in which the impression is displayed, also referred to as “impression time”. The information may be useful in computing ERPITU values for a time offset with respect to an ad impression.

In some exemplary embodiments, client-side script in the web page on Device 140 may be configured to send information to ERPITU Monitoring Server 130. The script may determine the time in which the ad was loaded, also referred to as “load time”, such as based on a load event when the script is initialized. The script may determine the time in which the ad is clicked, such as based on catching a triggered click event when the click is performed. Similarly, the script may determine the time in which any action which the ad compensation is contingent upon is performed. Click time may be computed by the script by subtracting the load time from the time of click/action. The click time may be transmitted by the script to ERPITU Monitoring Server 130. Additionally or alternatively, the computation may be performed by ERPITU Monitoring Server 130, such as based on receiving the time of click from Device 140, executing the script and obtaining the load time from either the Ad Serving Server 120 or from the script.

Additionally or alternatively, the script may determine removal time of the ad, such as based on catching a removal event of the script which may be triggered upon a command to the browser to exit the web page, to close the browser, to browse to a different web page, or the like. Based on the time in which the impression is removed and is no longer displayed, impression time may be computed.

In some exemplary embodiments, ERPITU Monitoring Server 130 may obtain information relating to the impression, such as characteristics of the user, the campaign, the placement, or the like, from the Ad Serving Server 120 and/or from Device 140.

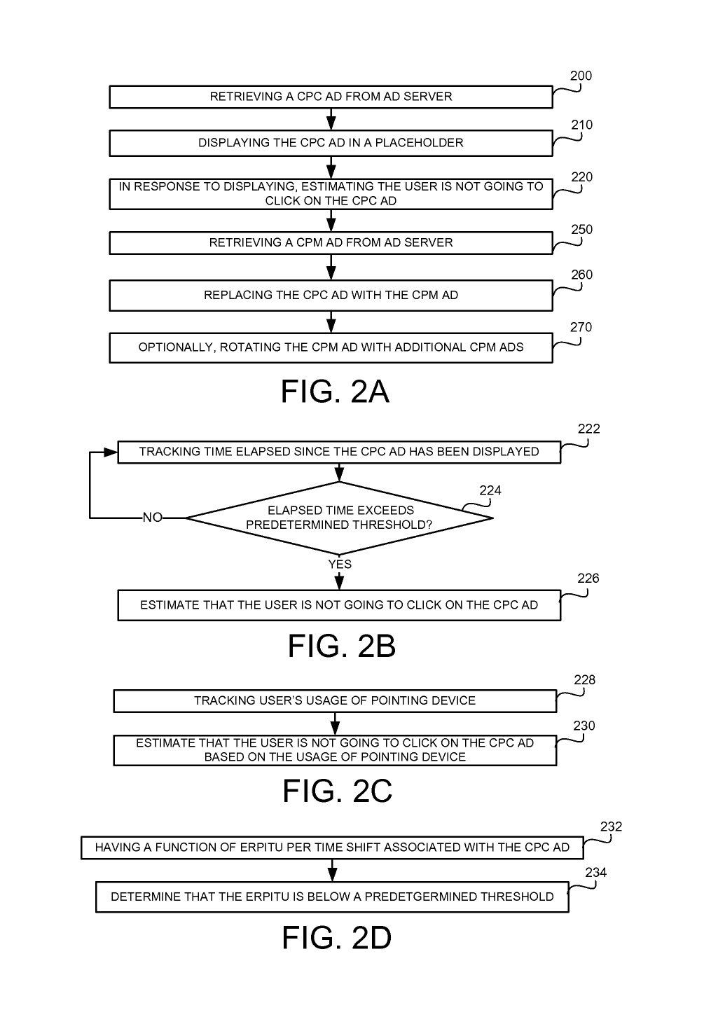

Referring now to FIG. 2A showing a method in accordance with an embodiment of the disclosed subject matter. The method is directed towards a CPC and CPM ads. However, the disclosed subject matter is not limited to such types of ads and other action-based ads and other serving-based ads may be used instead or in addition to CPC and CPM ads.

In Step 200, a CPC ad may be retrieved from an ad server, such as Ad Serving Server 120.

In Step 210, the CPC ad may be displayed in the placeholder within the web page.

In Step 220, and after the CPC ad was displayed, it may be estimated that the user has not and is not likely to click on the CPC. Additionally or alternatively, it may be estimated that the probability that the user will click the CPC ad is below a predetermined probability. Therefore, it may be estimated that no revenue is going to be generated from the current served CPC ad.

It will be noted that the estimation may be based on many factors, such as but not limited to elapsed time, usage of pointing device, portions of the web page being displayed, portions of the web page been looked at by the user, combination thereof, or the like. FIGS. 2B-2D disclose embodiments implementing Step 220 in some embodiments of the disclosed subject matter.

In Step 250, a CPM ad may be retrieved from the ad server or from another ad server and in Step 260 the CPC Ad may be replaced by the CPM ad. The CPM ad may generate revenue to the owner of the placeholder regardless of the user's activity.

In some embodiments, the CPM ad may be displayed only in case the placeholder is visible. For example, in case the placeholder is in a location which is not visible to the user due to scrolling, zooming, or other user actions, the CPM may not be displayed. In some exemplary embodiments, the CPM ad will be displayed once the placeholder becomes visible.

In some exemplary embodiments, additional CPM ads may be retrieved and rotated in the placeholder in Step 270. Each CPM ad may be displayed for a predetermined amount of time and then switched randomly, in a round-robin scheme, or in any other ordering scheme.

In some exemplary embodiments, the CPM ad may be retrieved (Step 250) together with the retrieval of the CPC ad. For billing purposes, an indication may be issued when the CPM ad is displayed, in order to let the ad server know whether the ad which was served was actually displayed and needs to be paid for or not.

Additionally or alternatively, both the CPM and CPC ads may be retrieved upon loading of the web page. Additionally or alternatively, the CPM ad may be retrieved dynamically with or without reloading the web page by a client-side script.

In some exemplary embodiments, a client side script may implement Steps 220, 250, 260, 270, or the like.

Referring now to FIG. 2B showing a method for estimating that the user in not going to click on the CPC ad, in accordance with an embodiment of the disclosed subject matter.

In Step 222, the time elapsed since the CPC ad was displayed may be tracked. In some embodiments, the elapsed time may refer only to the elapsed time in which the CPC ad was visible to the user. Additionally or alternatively, the elapsed time may refer to time elapsed after the CPC ad was displayed even if it was not visible to the user the whole time.

In response to a determination that the elapsed time exceeds a predetermined threshold, such as five seconds, seven seconds, twenty seconds, or the like, Step 226 may be performed and there may be an estimation that the user is not going to click on the CPC ad.

In some exemplary embodiments, the threshold may be predetermined based on an ERPITU value of the ad impression. A chart of the ERPITU of the ad impression may be available, such as based on a computation provided by ERPITU Monitoring Server 130. Based on the values of the ERPITU in different time offsets, the time duration during which the ERPITU is below a predetermined minimal threshold may be determined. The computation of the time offset may be performed by the script or by a server, such as ERPITU Monitoring Server 130, before the script is loaded. Additionally or alternatively, the computation may be performed by the server after the script is loaded and provided thereto.

FIG. 4A shows an Illustration 400 of the ERPITU as a function of the time offset. The first time unit on the time scale relates to the first time unit after the ad impression is displayed. The second time unit relates to the time unit that follows and so forth. As can be appreciated, the ERPITU may differ in different time offsets.

Charts 410, 420, 430 may each be related to a different ad impression, which may differ from one another in user characteristics, campaign characteristics, placement characteristics, a combination thereof, or the like. As a non-limiting example, Chart 410, 420, 430 may relate to the same ad, in the same placeholder but for a different user.

In some exemplary embodiments, some charts may have a decreasing trend from a certain point in time. This may be because that after some point, it is less and less likely that the user will perform the action (e.g., click). In some exemplary embodiments, initially there may be an increasing trend due to the fact that the ad may require the user some time to comprehend the message, to fully view the ad (e.g., view the video or slideshow), or the like.

Referring now to FIG. 4B which exemplifies that based on ERPITU Charts 410, 420, 430, a time unit in which the first ad is replaced may be determined. It may be determined that when the ERPITU decreases to values below a minimal ERPITU 450, the user is estimated as not going to perform the action. Based on minimal ERPITU 450 a different time offset may be determined for each Chart 410, 420, or 430. For Chart 410, based on an intersection point 412, time offset 414 may be determined as the time in which the first ad is replaced. For Chart 420, based on an intersection point 422, time offset 424 may be determined as the time in which the first ad is replaced. For Chart 430, based on intersection point 432, time offset 434 may be determined as the time in which the first ad is replaced.

Minimal ERPITU 450 may be determined based on expected alternative revenue from placing a serving-based ad instead of the first ad. For example, if the expected alternative revenue from the placement is 1 cent, the minimal ERPITU 450 may be about 1 cent. In some exemplary embodiments, Minimal ERIPTU 450 may be a bit higher than the expected alternative revenue, such as greater than the alternative revenue by 10%. In some exemplary embodiments, the alternative revenue from the placement may be compared with a summation of the ERIPTU in the current time unit and the following time units.

As can be appreciated, if Charts 410, 420, 430 relate to the same campaign and same placement but different user, the ad replacement will occur in a different time offset for each user.

Referring now back to FIG. 2B, in some exemplary embodiments, the predetermined threshold may be a different threshold for different users based on their history. For example, users that tend to click faster than others may be associated with a lower threshold.

In some embodiments, the threshold may be in the order of magnitude of a few seconds, and may be defined by the owner of the placeholder. The threshold may be defined so as to enable the user to grasp the CPC ad and interact with it if he so wishes. In some embodiments, a user that will interact with a CPC ad or other user action-based ad is likely to interact with it at an early stage after the web site has been reloaded, for example before directing his attention to the non-advertisement displayed content, if any is displayed.

Referring now to FIG. 2C showing a method for estimating that the user in not going to click on the CPC ad, in accordance with an embodiment of the disclosed subject matter.

In Step 228, the user's usage of a pointing device is tracked. The pointing device may be a computer mouse, a touchpad, a touch screen, or the like.

In Step 230, based on the user's usage of the pointing device it may be determined that the user is not likely to click on the CPC ad. In some exemplary embodiments, the pointing device may be directed towards a location in which the user is interested. The farther the distance between the location to which the pointing device is pointing and the placeholder of the CPC ad, the less likely it is that the user will click the CPC ad. Additionally or alternatively, a trend may be tracked indicating that the distance between the location pointed to by the pointing device and the location of the placeholder is growing rather than shrinking Additionally or alternatively, users that click on the CPC ad may be characterized by usage characteristics. As an example only, users that click on CPC ads may be characterized by using the pointing device to click on the CPC ad at an early stage. Therefore, if the user is using the pointing device to point to other locations (regardless of the time it takes the user to point to them), it may be determined that the user is not likely to click on the CPC ad.

In some exemplary embodiments, specific usage characteristics by the user may be tracked over time, for example by using machine learning techniques, to personalize the estimation based on the user's activity. Machine learning techniques may be used to provide estimation of a user's time to click based on the user characteristics, the campaign characteristics, the placement characteristics, a combination thereof, or the like.

Referring now to FIG. 2D showing a method for estimating that the user is not going to click on the CPC ad, in accordance with an embodiment of the disclosed subject matter.

In Step 232, a function of ERPITU associated with the ad impression of the CPC ad may be available, such as from an ERPITU monitoring server. The function may provide, for each offset time unit since the CPC ad is displayed/visible, the ERPITU value. As an example, and in case of a time unit of 1 second, the ERPITU of the first second may be 10 cents, the ERPITU of the next second may be 12 cents, the ERPITU of the third second may be 10 cents, the ERPITU of the fourth second may be 8 cents, and the ERPITU of the fifth second and any following second may be 3 cents.

In Step 234, based on the ERPITU value dropping below a predetermined threshold, the user may be estimated as not going to click on the CPC ad.

In some exemplary embodiments, the estimation may be based on the value of the ERPITU per the current time unit. Additionally or alternatively, the estimation may be based on the expected values of the consecutive time units. For example, the estimation may be based on the determination that the ERPITU will not exceed the predetermined threshold in the future, at any time or within a predetermined timeframe, or the like.

It will be noted that the estimation may be wrong. However, in some cases, given a large enough population, the estimation may be correct in a large portion of the cases, such as 80%, 90%, 95%, or the like.

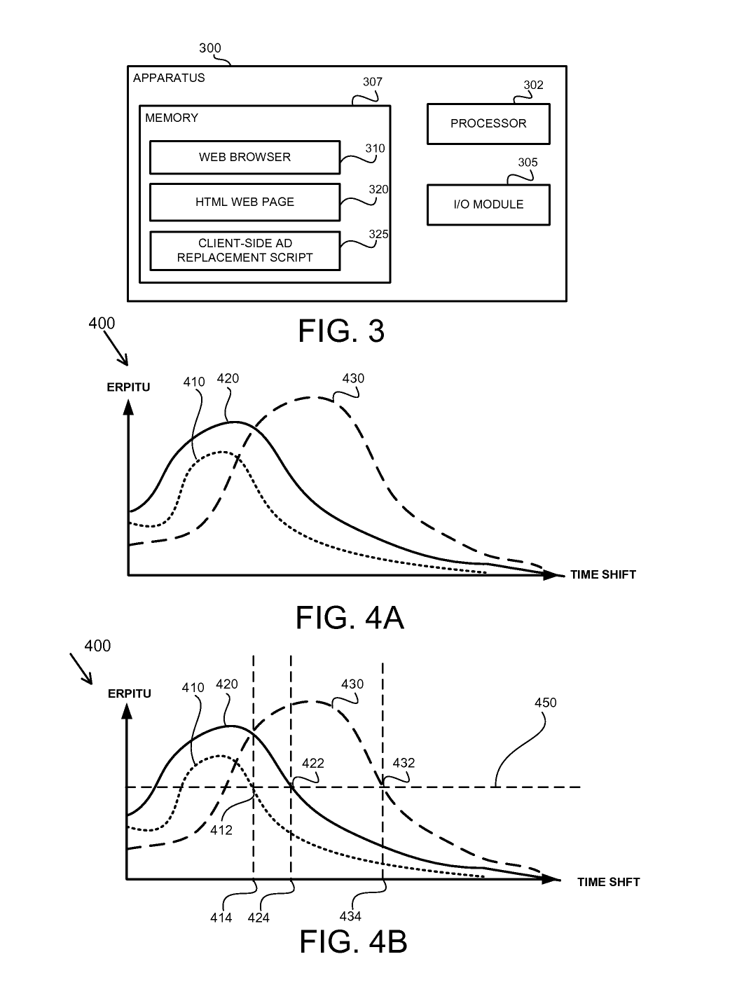

Referring now to FIG. 3 showing an Apparatus 300 in accordance with some exemplary embodiments of the disclosed subject matter.

In some exemplary embodiments, Apparatus 300 may comprise a Processor 302. Processor 302 may be a Central Processing Unit (CPU), a microprocessor, an electronic circuit, an Integrated Circuit (IC) or the like. Processor 302 may be utilized to perform computations required by Apparatus 300 or any of it subcomponents.

In some exemplary embodiments of the disclosed subject matter, Apparatus 300 may comprise an Input/Output (I/O) module 305. I/O module 305 may be utilized to provide output to and receive input from a user, an administrator, a placeholder owner, or the like. In some exemplary embodiments, I/O Module 305 may provide an interface to a computerized network, such as 105 of FIG. 1.

In some exemplary embodiments, Apparatus 300 may comprise a Memory Unit 307. Memory Unit 307 may be a short-term storage device or long-term storage device. Memory Unit 307 may be a persistent storage or volatile storage. Memory Unit 307 may be a disk drive, a Flash disk, a Random Access Memory (RAM), a memory chip, or the like. In some exemplary embodiments, Memory Unit 307 may retain program code operative to cause Processor 302 to perform acts associated with any of the subcomponents of Apparatus 300. In some exemplary embodiments, Memory Unit 307 may retain program code operative to cause Processor 302 to perform acts associated with any of the steps in FIG. 2A-2D above.

The components detailed below may be implemented as one or more sets of interrelated computer instructions, executed for example by Processor 302 or by another processor. The components may be arranged as one or more executable files, dynamic libraries, static libraries, methods, functions, services, or the like, programmed in any programming language and under any computing environment.

A Web Browser 310 may be configured to obtain web pages from servers in a computerized network, such as HTML Web Page 320. In response to obtaining HTML Web Page 320, it may be retained in Memory Unit 307. Web Browser 310 may be configured to render HTML Web Page 320 and provide a display thereof such as a graphical display, to a user. In some exemplary embodiments, Web Browser 310 may be configured to cause execution of client-side scripts, such as Client-Side Ad Replacement Script 325, in accordance with instructions embedded in or otherwise associated with the HTML Web Page 320.

HTML Web Page 320 may comprise the placeholder. The first ad that is initially displayed in the placeholder may be predetermined, may be served by an ad server to Apparatus 300, may be served by the web server with HTML Web Page 320, or the like. In some exemplary embodiments, the placeholder may comprise an HTML tag that initiates a request to the ad server to fulfill the placement opportunity.

Client-Side Ad Replacement Script 325 may be configured to estimate whether or not the user is likely to perform the action upon which the pricing module of the first ad is contingent. In response to such estimation, the script may replace the first ad by a second ad which may be a serving-based ad. The second ad may be fetched from an ad server, from another ad server, or the like. In some exemplary embodiments, the second ad may be fetched together with the HTML Web Page 320, with the first ad, or the like, and may be utilized only in case the first ad is replaced. In some exemplary embodiments, the second ad may be displayed in a rotatable placeholder together with additional serving-based ads.

In some exemplary embodiments, Client-Side Ad Replacement Script 325 may query a server, such as ERPITU Monitoring Server 130, to obtain a time offset in which the ERPITU of the ad impression drops below a predetermined threshold, and the displayed ad is to be replaced.

In some exemplary embodiments, the disclosed subject matter enables offering for sale the same placeholder in the same web site for the same placement opportunity two or more times. The pricing module may take into account the fact that an ad may not be displayed upon the web page loading but rather later on. The pricing may be based on an impression time unit, during which the ad impression is provided.

In some exemplary embodiments, a server, such as Ad Serving Server 120 of FIG. 1, may track the time elapsed since an ad is displayed in a web page. Based on the elapsed time, the compensation to be paid for the advertisement may be computed, such as by multiplying the rate per impression time unit by the number of elapsed time units during which the impression was displayed and/or visible to the user.

In some exemplary embodiments, the compensation may not be a-priori determined, as the total time in which the advertisement is shown may not be known in advance.

In some exemplary embodiments, a different price may be assigned to different time units. In some exemplary embodiments, the cost of the first time unit may be higher than the cost of later time units. Additionally or alternatively, each time unit may cost no more than the preceding time unit.

In some exemplary embodiments, a Cost Per Impression Time Unit (CPITU) may be used as a compensation model. The CPITU may be defined that for each impression time unit, the advertiser is charged by a predetermined rate. In some exemplary embodiments, the rate may or may not change for different time offsets. In some exemplary embodiments, CPITU may be defined with respect to a predetermined time frame, such as twenty time units, such that after the time frame ends, no additional charge is incurred.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method performed by a computerized device, comprising:
displaying a first advertisement in a web page, wherein the first advertisement is associated with a compensation model that is contingent on a user action by a user with the first advertisement; and
replacing the first advertisement by a second advertisement that is associated with a serving-based compensation model.

2. The computer-implemented method of claim 1, wherein said replacing is performed in response to a determination that a probability that the user action will be performed by the user is below a predetermined threshold.

3. The computer-implemented method of claim 1, wherein said replacing is performed in response to a determination that a predetermined threshold time has elapsed after said displaying the first advertisement.

4. The computer-implemented method of claim 3, wherein the predetermined threshold time is computed for an ad impression relating to the first advertisement, to the user and to the web page.

5. The computer-implemented method of claim 1, wherein said replacing is performed in response to estimating, based on usage of a pointing device by the user, that a probability that the user will perform the user action is below a predetermined threshold.

6. The computer-implemented method of claim 1, wherein said replacing is timed based on a computation of an Estimated Revenue Per Impressions Time Unit (ERPITU).

7. The computer-implemented method of claim 6, wherein said replacing is timed based on a time unit during which the ERPITU is below a predetermined revenue, wherein the predetermined revenue is associated with expected alternative revenue of the second advertisement.

8. The computer-implemented method of claim 1, wherein the serving-based compensation model is a Cost Per Mille-impression (CPM) compensation model.

9. The computer-implemented method of claim 1, wherein the serving-based compensation model is a Cost Per Impression Time Unit (CPITU) compensation model.

10. The computer-implemented method of claim 1, wherein the compensation model that is contingent on the interaction with the first advertisement is selected from the group consisting of:
a Cost Per Click (CPC) compensation model;
a Cost Per Action (CPA) compensation model; and
a Cost Per Lead (CPL) compensation model.

11. The computer-implemented method of claim 1, wherein said replacing comprises:
sending a request to an advertisement serving server to select the second advertisement from a set of advertisement that are associated with the serving-based compensation model; and
receiving from the advertisement server the second advertisement.

12. The computer-implemented method of claim 1 further comprises rotating the second advertisement with one or more additional advertisements that are associated with the serving-based compensation model.

13. The computer-implemented method of claim 1, wherein said replacing is performed without reloading the web page.

14. The computer-implemented method of claim 1, wherein said replacing comprises performing a passback, whereby an economic entity responsible for compensating is changed.

15. The computer-implemented method of claim 1, wherein said replacing is performed while the web page is displayed.

16. A computerized apparatus having a processor, the processor being adapted to perform the steps of:
displaying a first advertisement in a web page, wherein the first advertisement is associated with a compensation model that is contingent on a user action by a user with the first advertisement; and
replacing the first advertisement by a second advertisement that is associated with a serving-based compensation model.

17. The apparatus of claim 16, wherein said replacing is performed in response to a determination that a probability that the user action will be performed by the user is below a predetermined threshold.

18. The apparatus of claim 16, wherein said replacing is performed in response to a determination that a predetermined threshold time has elapsed after said displaying the first advertisement.

19. The apparatus of claim 18, wherein the predetermined threshold time is computed for an ad impression relating to the first advertisement, to the user and to the web page.

20. The apparatus of claim 16, wherein said replacing is timed based on a computation of an Estimated Revenue Per Impressions Time Unit (ERPITU).

21. The apparatus of claim 16, wherein said processor is further adapted to:
send a request to an advertisement serving server to select the second advertisement from a set of advertisement that are associated with the serving-based compensation model; and
receive from the advertisement server the second advertisement.

22. A computer program product comprising a non-transitory computer readable medium retaining program instructions, which instructions when read by a processor, cause the processor to perform the steps of:
displaying a first advertisement in a web page, wherein the first advertisement is associated with a compensation model that is contingent on a user action by a user with the first advertisement; and
replacing the first advertisement by a second advertisement that is associated with a serving-based compensation model.

23. The computer program product of claim 22, wherein the instructions when ready by the processor further cause the processor to perform the steps of:
obtaining from a server a time threshold in which said replacing is to be performed;
wherein said replacing is performed in response to a determination that an elapsed time since said displaying exceeds the time threshold.

24. The computer program product of claim 23, wherein the time threshold is computed by the server based on parameters associated with the user.

25. A computer-implemented method performed by a computerized device, comprising:
tracking time elapsed after an advertisement is displayed in a web page; and
computing a compensation to be paid for the advertisement based on the time elapsed.
